(19) United States
(12) Patent Application Publication
(10) Pub. No.: US 2014/0202622 A1
(43) Pub. Date: Jul. 24, 2014

(54) MOLDING ROLLER, APPARATUS AND METHOD FOR MANUFACTURING SAME

(71) Applicant: HON HAI PRECISION INDUSTRY CO., LTD., New Taipei (TW)

(72) Inventor: CHIA-LING HSU, New Taipei (TW)

(73) Assignee: HON HAI PRECISION INDUSTRY CO., LTD., New Taipei (TW)

(21) Appl. No.: 13/954,064

(22) Filed: Jul. 30, 2013

(30) Foreign Application Priority Data
Jan. 24, 2013 (TW) 102102576

(51) Int. Cl. B29D 99/00

(52) U.S. Cl. CPC B29D 99/0032
USPC 156/187; 156/382; 156/379.6

(57) ABSTRACT

An apparatus includes a metallic plate, a mixing assembly, a curing device, a receiving container, a mounting device, a cutting device, and a vacuum chamber. The metallic plate has a planar imprinting surface. The mixing assembly obtains a molding film material. The curing device cures the molding film material on the imprinting surface of the metallic plate to obtain an original film. The receiving container allows the original film to be immersed in a reaction liquid until the reaction liquid is absorbed by the original film, thereby obtaining a preprocessed molding film. The mounting device winds the preprocessed molding film around a main body. The cutting device cuts the preprocessed molding film to obtain a preprocessed molding roller. The vacuum chamber promotes the chemical reaction of the preprocessed molding film with the reaction liquid to form a number of silica nanoparticles in the preprocessed molding film.

### BACKGROUND

1. Technical Field

The present disclosure relates to a molding roller, an apparatus and a method for manufacturing the molding roller.

2. Description of Related Art

Optical films include a number of micro structures. One method for forming the micro structures is a roll forming process using a metallic roller. The metallic roller has a circumferential surface including molding patterns for forming the micro structures. The molding pattern is formed by a laser knife. However, it is difficult to machine the molding patterns on a curved surface of the metallic roller, therefore, the machining efficiency is relatively low.

Therefore, it is desirable to provide a molding roller, an apparatus and a method for manufacturing the molding roller that can overcome the above-mentioned limitations.

### BRIEF DESCRIPTION OF THE DRAWINGS

Many aspects of the embodiments should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a molding roller, according to a first exemplary embodiment.

FIG. 2 is a schematic view of an apparatus for manufacturing a molding roller, according to a second exemplary embodiment.

FIG. 3 to FIG. 4 are flowcharts of a method for manufacturing a molding roller, according to a third exemplary embodiment.

### DETAILED DESCRIPTION

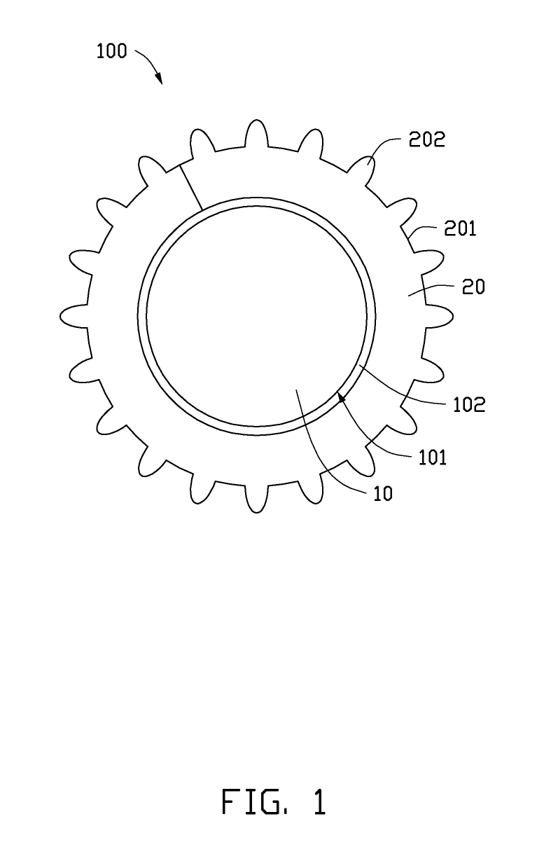

FIG. 1 illustrates a molding roller 100 in accordance to a first exemplary embodiment. The molding roller 100 includes a cylindrical main body 10 and a ring-shaped molding film 20. The main body 10 includes a circumferential surface 101, and can be made of stainless steel or other metals. The circumferential surface 101 is coated with an adhesive glue 102.

The molding film 20 is wound around and fixed to the circumferential surface 101 via the adhesive glue 102. The molding film 20 includes a molding surface 201 opposite to the main body 10. The molding surface 201 includes a number of molding patterns 202. In the first embodiment, the molding patterns 202 are micro striped protrusions. In other embodiments, the molding patterns 202 can be micro-dots, micro domes, or micro striped grooves.

The molding film 20 is made of flexible polymer material. The flexible polymer material consists of polymer resin and a number of silica nanoparticles formed in polymer grids of the polymer resin. In the first embodiment, the polymer resin is polydimethylsiloxane (PDMS) resin, and the silica nanoparticles are formed by sol-gel method.

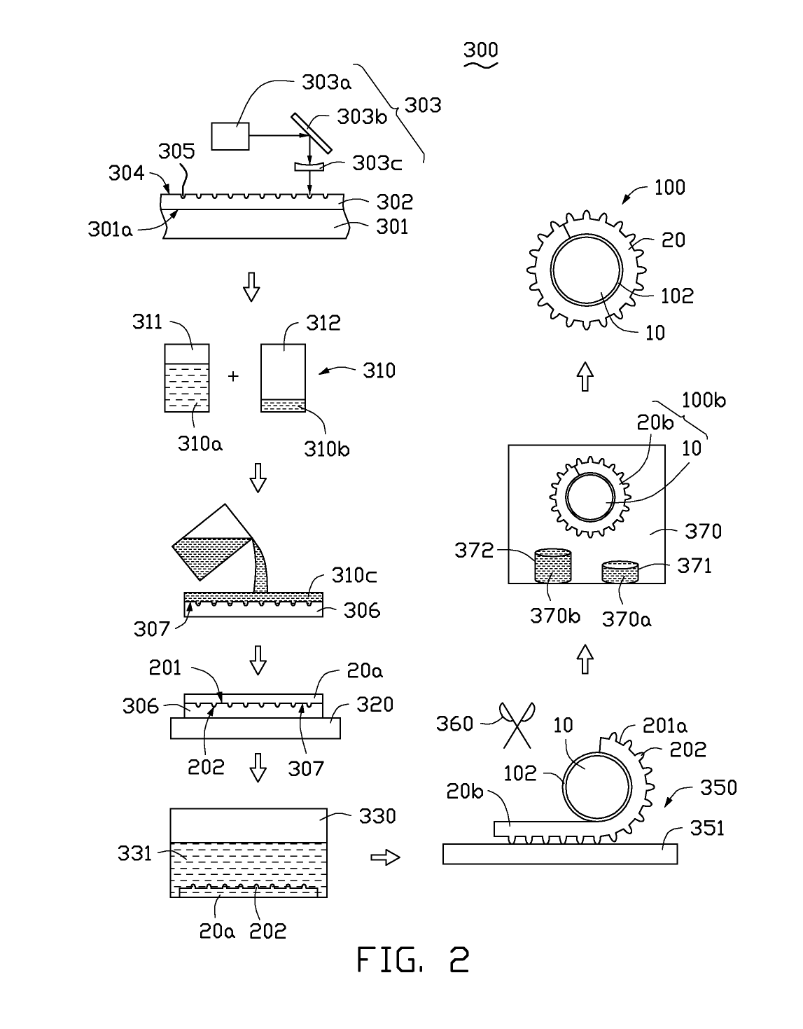

FIG. 2 shows an apparatus 300 for manufacturing the molding roller 100, according to a second exemplary embodiment. The apparatus 300 includes a loading plate 301, a preprocessed metallic plate 302, a processing device 303, a mixing assembly 310, a curing device 320, a receiving chamber 330, a mounting device 350, a cutting device 360, and a vacuum chamber 370.

The loading plate 301 has a planar loading surface 301a. The preprocessed metallic plate 302 is fixed to the planar loading surface 301a, and includes a planar preprocessed impression surface 304 opposite to the loading plate 301. The processing device 303 is used for forming a number of impression patterns 305 on the planar preprocessed impression surface 304 to obtain a metallic plate 306 with an impression surface 307. In the second embodiment, the impression patterns 305 are micro striped grooves, and the processing device 303 includes a laser emitter 303a, a reflector 303b, and a converging lens 303c. The laser emitter 303a is used for emitting laser rays. The transmitting direction of the laser rays is substantially parallel to the preprocessed impression surface 304. The reflector 303b is used for changing the transmitting direction of the laser rays and reflecting the laser rays to the converging lens 303c. The converging lens 303c converges the laser rays to the preprocessed impression surface 304. In other embodiments, the reflector 303b and the converging lens 303c can be omitted, and the transmitting direction of the laser rays should be substantially perpendicular to the preprocessed impression surface 304. In other embodiments, if the impression patterns 305 are V-shaped grooves, and the processing device 303 can include a diamond knife having a V-shaped blade.

The mixing assembly 310 includes a first container 311 and a second container 312. The first container 311 is used for receiving a PDMS base 310a, and the second container 312 is used for receiving a curing agent 310b. The weight ratio of the PDMS base 310a to the curing agent 310b is about 10:1. When the PDMS base 310a is mixed with the curing agent 310b, the PDMS base 310a chemically reacts with the curing agent 310b to harden the PDMS base 310a, and thus the polymer resin 310c (i.e. PDMS resin) having polymer grids is obtained. The polymer resin 310c is uniformly applied on the impression surface 307 of the metallic plate 306. In the second embodiment, the first container 311 and the second container 312 can be measuring glasses.

The curing device 320 is used for curing the polymer resin 310c on the metallic plate 306 to obtain an original film 20a. In the second embodiment, the curing device 320 includes a heater directly supporting the metallic plate 306. When the temperature of the heater is gradually increased, the polymer resin 310c can be cured to obtain the original film 20a. The original film 20a has a molding surface 201 in contact with the impression surface 307, and thus the molding surface 201 has a number of molding patterns 202 mated with the impression patterns 305. In the second embodiment, the molding patterns 202 are micro striped protrusions.

The receiving container 330 is used for receiving a reaction liquid 331. In the second embodiment, the reaction liquid 331 includes tetraethoxy silane (TEOS). The original film 20a is lifted off the metallic plate 306 and is immersed in the reaction liquid 331 for a predetermined period until the reaction liquid 331 is absorbed by the original film 20a, then the original film 20a is taken out from the receiving container 330, and the reaction liquid 331 covered on the original film 20a is removed. The original film 20a and the reaction liquid 331 penetrating the original film 20a are cooperatively form a preprocessed molding film 20b.

The mounting device 350 is used for mounting the preprocessed molding film 20b on the circumferential surface 101 of the main body 10, and includes a working platform 351. The preprocessed molding film 20b is positioned on the working platform 351, and the molding patterns 202 are in contact with the working platform 351. The circumferential surface 101 is coated with the adhesive glue 102, and the main body 10 presses an end of the preprocessed molding film 20b, then the main body 10 is rolled on the preprocessed molding film 20b to make the preprocessed molding film 20b wound around the circumferential surface 101 of the main body 10.

The cutting device 360 is used for cutting the preprocessed molding film 20b. The preprocessed molding film 20b and the main body 10 corporate to form the preprocessed molding roller 100b.

The vacuum chamber 370 receives a third container 371 and a fourth container 372. The third container 371 receives an alkaline catalyst 370a, and the fourth container 372 receives a deionized water 370b. In the second embodiment, the alkaline catalyst is 95% 2-amino-2-methyl-propanol solution (AMP-95), and the volume ratio of the alkaline catalyst 370a to the deionized water 370b is about 1:5. The preprocessed molding roller 100b is received in the vacuum chamber 370, and is positioned above the third container 371 and the fourth container 372. When the temperature of the vacuum chamber 370 is gradually increased, the alkaline catalyst 371 and the deionized water 372 are vaporized to arrive at the preprocessed molding film 20b to promote the chemical reaction of the preprocessed molding film 20b with the reaction liquid 330b, and thus the growth rate of the silica nanoparticles is increased to obtain the molding film 20. The molding film 20 and the main body 10 cooperatively form the molding roller 100.

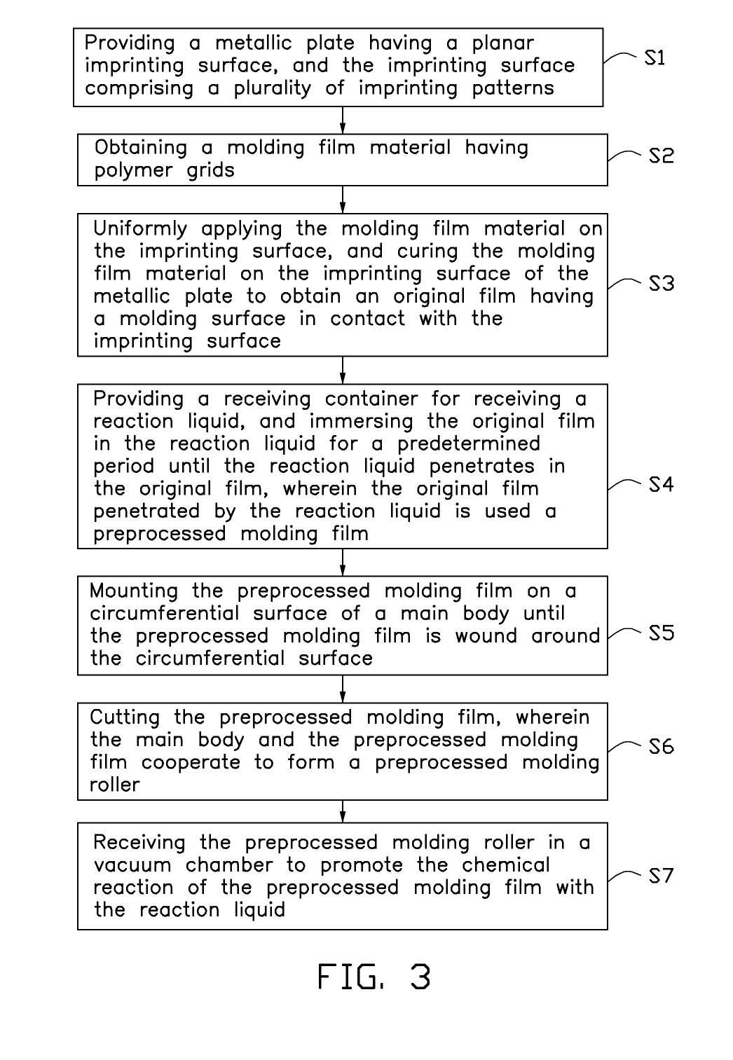

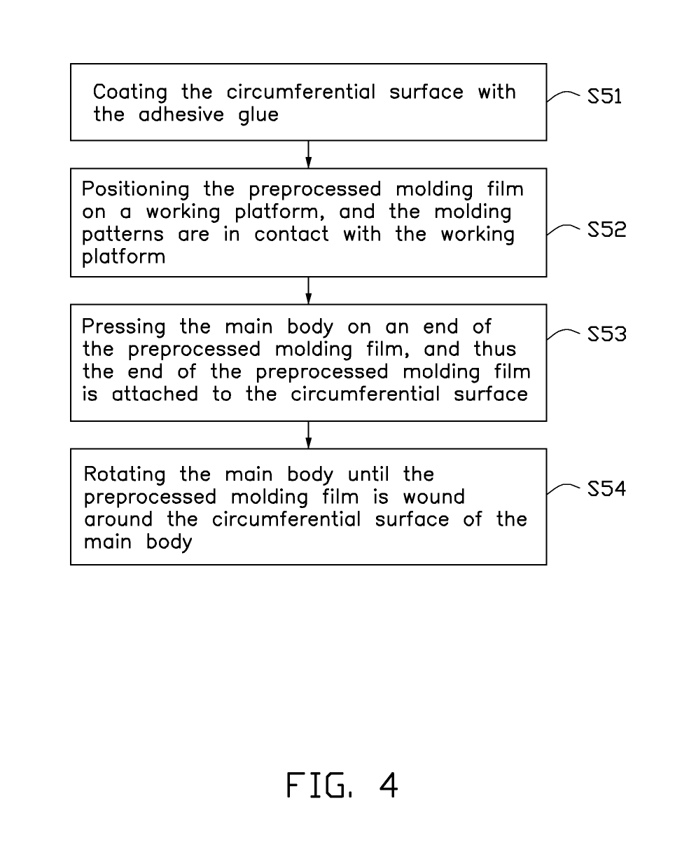

Referring to FIG. 3, a method for manufacturing the molding roller 100 using the apparatus 300, according to a third exemplary embodiment, includes the following steps.

In step S1, the preprocessed metallic plate 302 is fixed to the planar loading surface 301a of the loading plate 301. The impression patterns 305 are formed on the planar preprocessed impression surface 304 using the processing device 303 to obtain the metallic plate 306 and the impression surface 307.

In step S2, the PDMS base 310a and the curing agent 310b are mixed using the mixing device 310, and thus to obtain the polymer resin 310c having polymer grids. In the third embodiment, the first container 311 receives the PDMS base 310a, the second container 312 receives the curing agent 310b, and the weight ratio of the PDMS base 310a to the curing agent 310b is about 10:1.

In step S3, the polymer resin 310c is uniformly distributed on the impression surface 307 of the metallic plate 306, and the polymer resin 310c is cured using the curing device 320 to obtain the original film 20a. The original film 20a has the molding surface 201 in contact with the impression surface 307, and defines a number of molding patterns 202 mated with the impression patterns 305.

In step S4, the original film 20a is separated from the metallic plate 306, and is immersed in the reaction liquid 331 (such as TEOS) for the predetermined period until the reaction liquid 331 is absorbed by the original film 20a, then the original film 20a is taken out from the reaction liquid 331, and the reaction liquid 331 covered on the original film 20a is removed. The original film 20a and the reaction liquid 331 penetrating the original film 20a are cooperatively formed a preprocessed molding film 20b.

In step S5, the preprocessed molding film 20b is wound around and is fixed to the circumferential surface 101 of the main body 10 using the mounting device 350.

In step S6, the preprocessed molding film 20b is cut. The preprocessed molding film 20b and the main body 10 cooperatively form the preprocessed molding roller 100b.

In step S7, the preprocessed molding roller 100b is received in the vacuum chamber 370, and is positioned above the alkaline catalyst 370a and the deionized water 370b, then the temperature of the vacuum chamber 370 is gradually increased, the alkaline catalyst 370a and the deionized water 370b are vaporized to arrive at the preprocessed molding film 20b to promote the chemical reaction of the preprocessed molding film 20b with the reaction liquid 331, and thus the growth rate of the silica nanoparticles is increased to obtain the molding film 20 and the molding roller 100.

In other embodiments, the order of the step S5 and the step S6 can be interchanged.

Referring to FIG. 5, the step S5 further includes the following sub-steps.

In step S51, the circumferential surface 101 is coated with the adhesive glue 102.

In step S52, the preprocessed molding film 20b is positioned on the working platform 351, and the molding patterns 201 is in contact with the working platform 351.

In step S53, the main body 10 presses an end of the preprocessed molding film 20b, and thus the end of the preprocessed molding film 20b is attached to the circumferential surface 101.

In step S54, the main body 10 is rotated until the preprocessed molding film 20b is wound around the circumferential surface 101 of the main body.

By employing the apparatus 300 and the above described method, it is easier for the processing device 303 to machine the impression patterns 305 on the planar preprocessed impression surface 304 relative to on a curved surface. Therefore, the machining efficiency is improved.

It will be understood that the above particular embodiments and methods are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An apparatus for manufacturing a molding roller, comprising:
a metallic plate having a planar imprinting surface, and the imprinting surface comprising a plurality of imprinting patterns;
a mixing assembly configured for obtaining a molding film material having polymer grids, and the molding film material being applied on the imprinting surface;
a curing device configured for curing the molding film material on the imprinting surface of the metallic plate to obtain an original film having a molding surface in contact with the imprinting surface; and the molding surface comprising a plurality of molding patterns coupled with the imprinting patterns;
a receiving container configured for receiving a reaction liquid, and allowing the original film to be immersed in the reaction liquid for a predetermined period until the reaction liquid absorbed by the original film, thereby obtaining a preprocessed molding film including the original film and the reaction liquid penetrating the original film;
a mounting device configured for mounting the preprocessed molding film on a circumferential surface of a main body until the preprocessed molding film is wound around the circumferential surface;
a cutting device configured for cutting the preprocessed molding film, and the main body and the preprocessed molding film cooperatively forming a preprocessed molding roller; and
a vacuum chamber configured for receiving the preprocessed molding roller, and promoting the chemical reaction of the preprocessed molding film with the reaction liquid to form a plurality of silica nanoparticles in the polymer grids of the preprocessed molding film to obtain a molding film, and the molding film and the main body cooperating to form the molding roller.

2. The apparatus of claim 1, further comprising a processing device and a loading plate, wherein the processing device is configured for forming a plurality of impression patterns on a preprocessed metallic plate to obtain the metallic plate, the loading plate is configured for fixing the preprocessed metallic plate, the preprocessed metallic plate has a preprocessed impression surface opposite to the loading plate.

3. The apparatus of claim 2, wherein the processing device comprises a laser emitter, a reflector, and a converging lens, the laser emitter emits laser rays, the transmitting direction of the laser rays is substantially parallel to the preprocessed impression surface, the reflector changes the transmitting direction of the laser rays and reflecting the laser rays to the converging lens, the converging lens converges the laser rays to the preprocessed impression surface.

4. The apparatus of claim 1, wherein the mixing assembly comprises a first container and a second container, the first container is configured for receiving a polydimethylsiloxane base, and the second container is configured for receiving a curing agent, the polydimethylsiloxane base chemically reacts with the curing agent to harden the polydimethylsiloxane base, and thus the polymer resin having polymer grids is obtained.

5. The apparatus of claim 4, wherein the weight ratio of the polydimethylsiloxane base to the curing agent is about 10:1.

6. The apparatus of claim 4, wherein the reaction liquid comprises tetraethoxy silane.

7. The apparatus of claim 4, wherein the vacuum chamber receives a third container and a fourth container, the third container receives an alkaline catalyst, and the fourth container receives a deionized water, the preprocessed molding roller is positioned above the third container and the fourth container.

8. The apparatus of claim 1, wherein the mounting device comprises a working platform, the preprocessed molding film is positioned on the working platform, and the molding patterns are in contact with the working platform, the circumferential surface is coated with an adhesive glue, and the main body presses an end of the preprocessed molding film, then the main body is rolled on the preprocessed molding film to make the preprocessed molding film wind around the circumferential surface of the main body.

9. The apparatus of claim 1, wherein the curing device comprises a heater directly supporting the metallic plate to solidify the molding film material on the metallic plate.

10. A method for manufacturing a molding roller, comprising:
providing a metallic plate having a planar imprinting surface, and the imprinting surface comprising a plurality of imprinting patterns;
obtaining a molding film material having polymer grids;
uniformly applying the molding film material on the imprinting surface, and curing the molding film material on the imprinting surface of the metallic plate to obtain an original film having a molding surface in contact with the imprinting surface; and the molding surface comprising a plurality of molding patterns coupled with the impression patterns;
providing a receiving container for receiving a reaction liquid, and immersing the original film in the reaction liquid for a predetermined period until the reaction liquid is absorbed by the original film, thereby obtaining a preprocessed molding film including the original film and the reaction liquid penetrating the original film;
mounting the preprocessed molding film on a circumferential surface of a main body until the preprocessed molding film is wound around the circumferential surface;
cutting the preprocessed molding film, wherein the main body and the preprocessed molding film cooperatively form a preprocessed molding roller; and
placing the preprocessed molding roller in a vacuum chamber to promote the chemical reaction of the preprocessed molding film with the reaction liquid, and thus forming a plurality of silica nanoparticles in polymer grids of the preprocessed molding film to obtain a molding film, wherein the molding film and the main body cooperatively form a molding roller.

11. The method of claim 10, wherein the step of obtaining a molding film material having polymer grids further comprises:
receiving a polydimethylsiloxane base in a first container;
receiving a curing agent in a second container; and
mixing the polydimethylsiloxane base with the curing agent.

12. The method of claim 10, wherein receiving the preprocessed molding roller in a vacuum chamber to promote the chemical reaction of the preprocessed molding film with the reaction liquid further comprises:
receiving a third container and a fourth container in the vacuum chamber;
receiving an alkaline catalyst in the third container;
receiving a deionized water in the fourth container; and
gradually increasing the temperature of the vacuum chamber until the alkaline catalyst and the deionized water are vaporized to arrive at the preprocessed molding film.

13. The method of claim 12, wherein the weight ratio of the polydimethylsiloxane base to the curing agent is about 10:1.

14. The method of claim 12, wherein the reaction liquid comprises tetraethoxy silane.

15. The method of claim 10, wherein the step of mounting the preprocessed molding film on a circumferential surface of a main body until the preprocessed molding film is wound around the circumferential surface further comprises:
coating the circumferential surface with the adhesive glue;
positioning the preprocessed molding film on a working platform, and the molding patterns are in contact with the working platform;
pressing the main body on an end of the preprocessed molding film, and thus the end of the preprocessed molding film is attached to the circumferential surface; and
rotating the main body until the preprocessed molding film is wound around the circumferential surface of the main body.
